(19) United States
(12) Patent Application Publication
(10) Pub. No.: US 2003/0095024 A1
(43) Pub. Date: May 22, 2003

(54) Transformer

(75) Inventor: Jens Frank Markwardt, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: FRIWO Far East Limited, Kwai Fong (HK)

(21) Appl. No.: 10/294,907

(22) Filed: Nov. 15, 2002

(30) Foreign Application Priority Data
Nov. 19, 2001 (EP) 01309737.3

(51) Int. Cl. H01F 27/02

(52) U.S. Cl. 336/90

(57) ABSTRACT

A transformer includes first and secondary transformer windings (7, 8) formed on an iron core (6). The core (6) and windings (7, 8) are disposed in an enclosure (1a, 1b). There are first and second electrical pins (2, 3) in electrical connection with the primary transformer winding (7). A second inner enclosure (16) made of fire retardant material encases a portion of the electrical pins (2, 3) and the primary transformer winding (7) in connection with the electrical pins (2, 3).

### FIELD OF THE INVENTION

The present invention relates to transformers, and in particular to low voltage “plug-pack” transformers used for battery chargers in or for rechargeable consumer products.

### BACKGROUND TO THE INVENTION

Low voltage plug-packed transformers for use with battery chargers of rechargeable consumer products are known. The transformer comprises an iron core carrying first and secondary transformer windings. The transformer is housed within an enclosure. Projecting from the outer surface of the enclosure are electrical pins adapted to engage an electrical wall outlet. The pins are in electrical connection with the primary winding for energising the transformer. The secondary winding is connected to a rectifier and output cord.

In order to comply with electrical safety standards the enclosure must be made from fire retardant material. The choice of material depends on the operating temperature and normal fault operating temperature of the transformer according to various international safety standards such as UL1950 or EN60950. Fire retardant material is more expensive then normal plastics material and this adds to the cost of the enclosure.

### OBJECT(S) OF THE INVENTION

It is an object of the present invention to provide a transformer and/or battery charger assembly that overcomes or substantially ameliorates at least one of the above disadvantage or at least provides the public with a useful alternative.

### DISCLOSURE OF THE INVENTION

There is disclosed herein an electrical transformer, comprising:

a housing,

a core located within the housing,

a primary transformer winding carried by the core and having first and second tails,

a secondary transformer winding carried by the core,

first and second electrical connectors connected electrically to respective said tails of the primary transformer winding, and

a shield positioned between the tails of the primary transformer winding and the housing.

Preferably the shield is fire-retardant.

Preferably the shield extends between the primary winding and the housing.

Preferably said or another shield extends between the secondary winding and the housing.

Preferably the transformer includes an electrical pin assembly detachable from the first and second electrical connectors, said pin assembly comprising a pair of pins that project from the housing to facilitate connection of the transformer with an electrical wall outlet.

Preferably the transformer includes a winding bobbin that is formed integrally with the shield.

There is further disclosed herein a battery charger including:

a housing,

a core located within the housing,

a primary transformer winding carried by the core and having first and second tails,

a secondary transformer winding carried by the core,

first and second electrical connectors connected electrically to respective said tails of the primary transformer winding, and

a fire-retardant shield positioned between the tails of the primary transformer winding and the housing.

Preferably not primary winding is formed on a bobbin that is formed in integrally with the shield.

### BRIEF DESCRIPTION OF THE DRAWINGS

Preferred forms of the invention will now be described by way of example with reference to the accompanying drawings, wherein:

FIG. 1 is a schematic perspective illustration of a transformer plug-pack having pins in a European configuration,

FIG. 2 is a schematic inverted perspective illustration of the transformer plug-pack of FIG. 1,

FIG. 3 is a schematic parts-exploded perspective illustration of the plug-pack of FIGS. 1 and 2 showing a two-part shield adjacent to the prime rewinding of the transformer,

FIG. 4 is a schematic cross-sectional elevational view of the plug-pack of FIG. 3 after assembly,

FIG. 5 is a schematic parts-exploded perspective illustration of a transformer plug-pack having a British pin configuration and a unitary shield of larger size protecting not only the primary winding, but also the second rewinding of it's transformer,

FIG. 6 is a schematic cross-sectional side elevational view of the transformer plug-pack of FIG. 5,

FIG. 7 is a schematic parts-exploded perspective illustration of a transformer plug-pack having pins in a US configuration and a two-part shield posithe thetioned adjacent both it's primary and secondary windings,

FIG. 8 is a schematic perspective scratch that parts-exploded perspective illustration of a transformer plug-pack having pins in a US configuration and a unitary shield positioned adjacent both it's primary and secondary windings,

FIG. 9 is a schematic cross-sectional elevational view of a transformer plug-pack similar to that of FIG. 4, but having pins in a British configuration, and

FIG. 10 is a schematic cross-sectional elevational view of a transformer plug-pack similar to that of FIGS. 4 and 9, but having pins in a US configuration.

### DESCRIPTION OF THE PREFERRED EMBODIMENTS

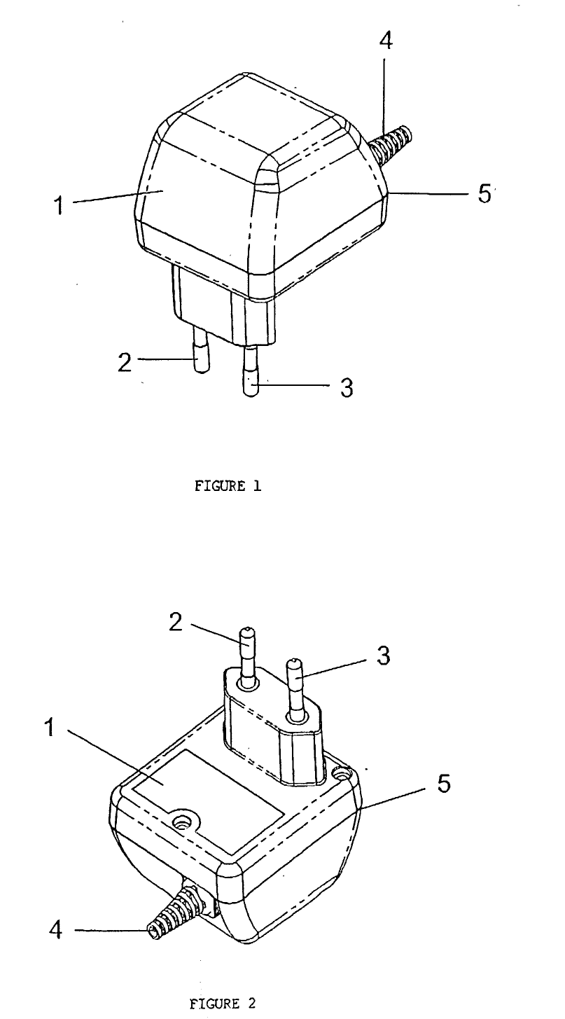

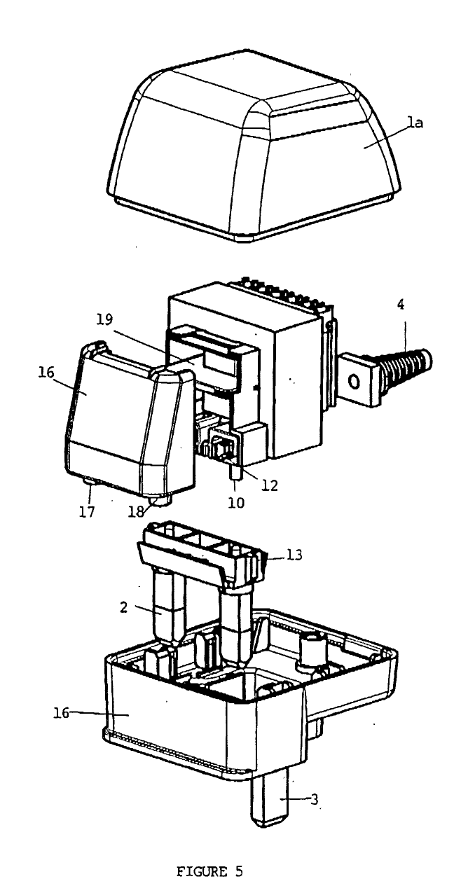

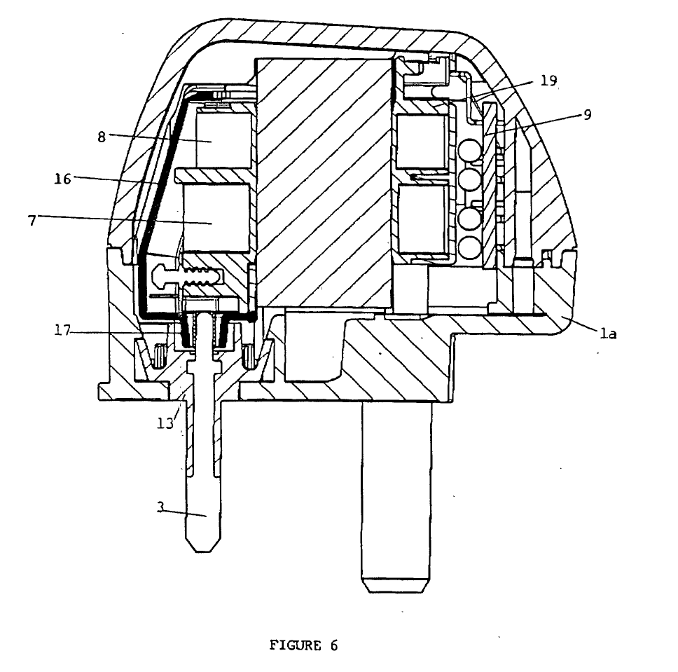

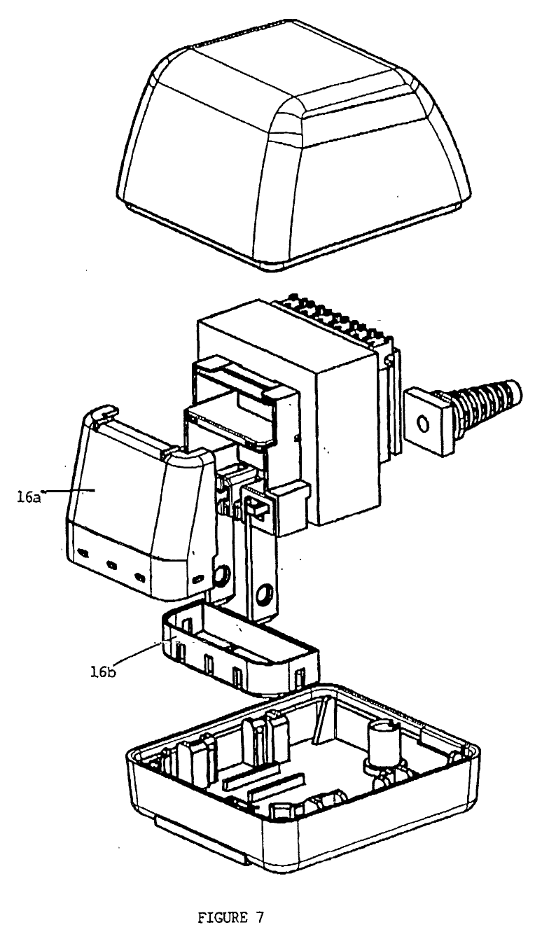

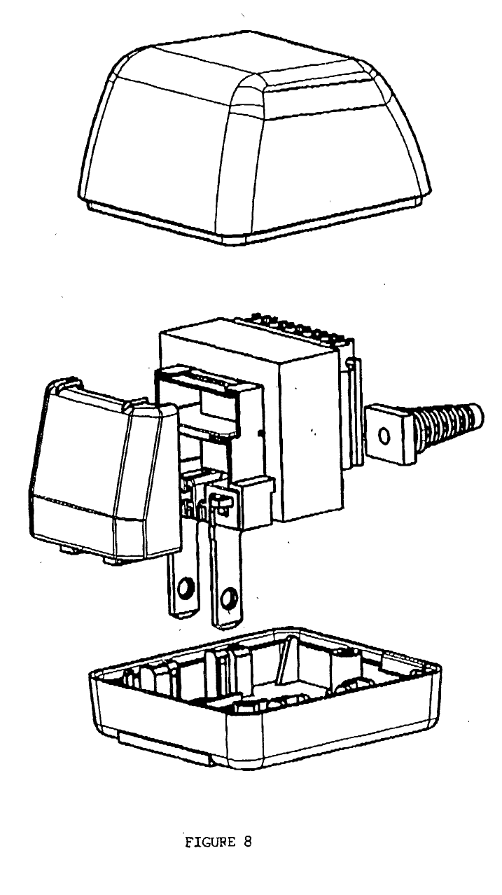

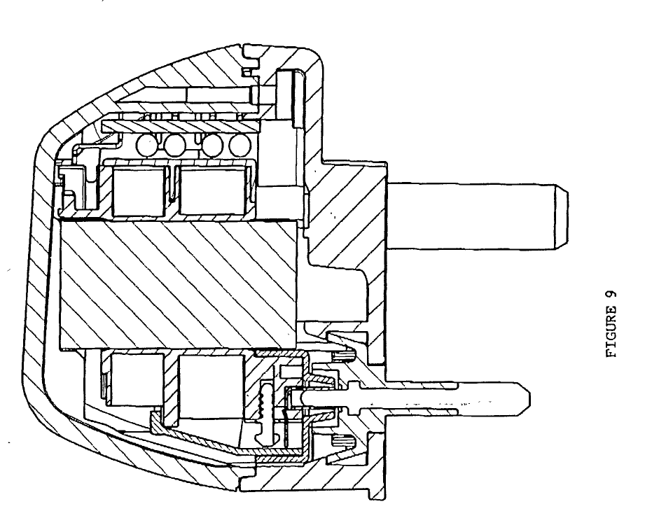

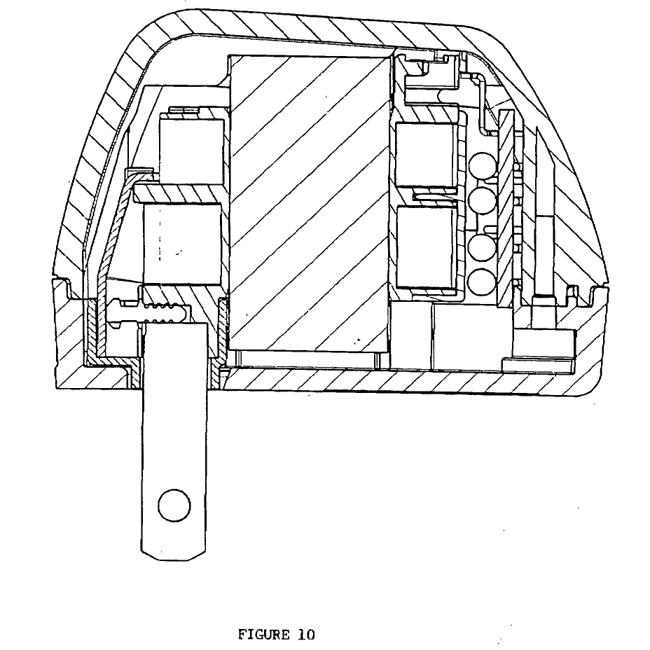

Preferred embodiments of the invention will now be described with reference to the Figures, in which FIGS. 1 to 4, 7 and 8 show pins in a European configuration, whereas FIGS. 5, 6 and 9 show pins in a British configuration, and FIG. 10 shows a transformer plug-pack having US-configured pins.

The following description refers equally to each pin configuration and like reference numerals refer to like features.

FIGS. 1 and 2 are perspective views of a battery charger that, externally, is substantially identical to those of known type. An enclosure 1 houses a transformer and rectifier. Electrical pins 2 and 3 project from one side of the enclosure 1 and are connected electrically with the transformer. The pins 2 and 3 are adapted to plug into an electrical wall outlet (not shown) to energise the transformer. An electrical output cord (not shown) emerges from an aperture (shown with cord protector 4) in the enclosure 1.

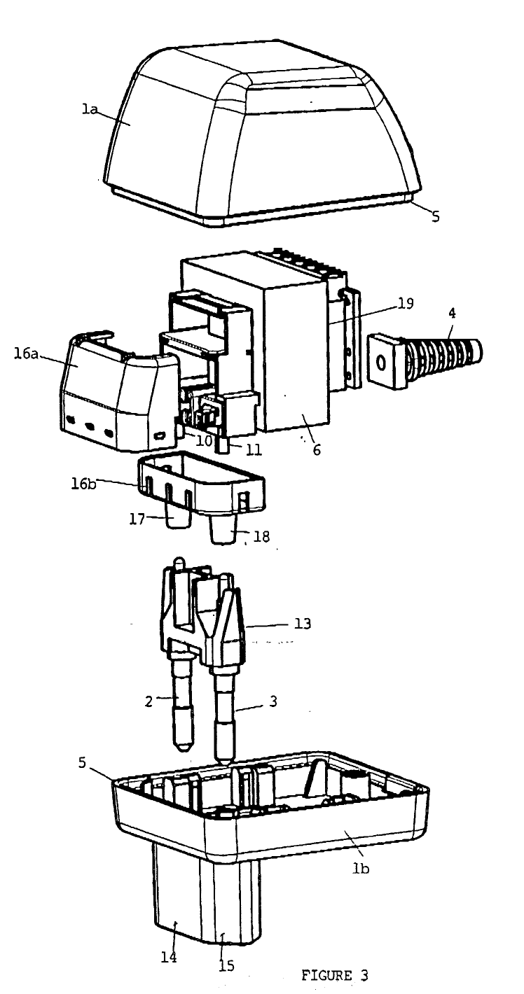

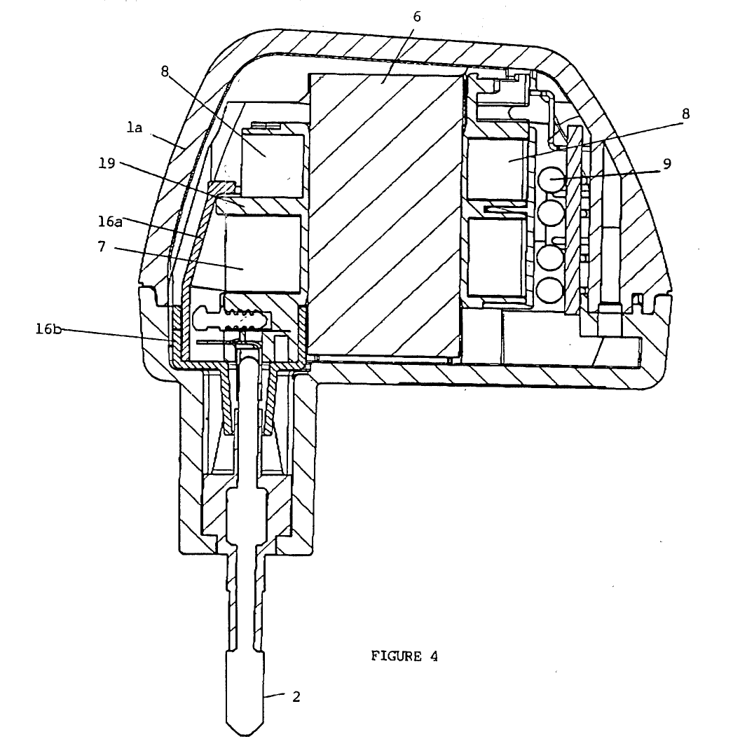

Referring to FIGS. 3 and 4, the enclosure 1 is separable at an equator 5 into two enclosure parts 1a and 1b. Within the enclosure 1 is a transformer comprising an core 6 carrying a winding bobbin 19 with a first, or primary, winding 7 and second, or secondary, winding 8 wound thereon. The secondary winding 8 is in electrical connection with a rectifier 9 for providing a low voltage DC output from the battery charger. Alternatively, the plug-pack might be adapted for use in AC applications in which case there would be no rectifier.

The tails (not shown) of the primary winding 7 are connected to electrical connectors 10 and 11 respectively. The electrical connectors 10 and 11 are supported in a housing 12 at one end of bobbin 19.

A cartridge 13 bears the two electrical pins 2 and 3. The cartridge 13 is disposed in juxtaposition on enclosure part 1b so that pins 2 and 3 extend through apertures 14 and 15 therein.

When the two enclosure parts 1a and 1b are brought together to enclose the transformer, the lower end of the electrical pins 2 and 3 engage the electrical connectors 10 and 11 to electrically communicate with the primary transformer winding 7. In this way, when the electrical pins are pluged into an electrical wall outlet the transformer is energised.

One uniqueness of the illustrated embodiments is the provision of a shield or cover 16 that protects the enclosure parts 1a and 1b from any sparks or flames that might be generated from the vicinity of the electrical connectors 10 and 11 and at least the tail portions of transformer primary winding 7.

The shield 16 can comprise an upper shield portion 16a that can extend alongside and adjacent the primary winding 7 as shown in FIG. 3, or might extend further to alongside and adjacent the secondary winding 8 as shown in FIG. 7. The bottom extremity of the upper shield part 16a is received within the bottom shield part 16b. On the other hand, the shield 16 can be a unitary piece that extends from the vicinity of the electrical connectors 10 and 11 and at least the tale portions of the transformer primary winding 7 to alongside and adjacent the secondary winding 8. Either way, the shield 16, or shield parts 16a and 16b are fabricated from a fire-retardant material so as to protect the housing parts 1a and 1b from sparks and/or heat. In this regard, it might be worth noting that heat can be generated by the windings themselves.

The cover 16, or lower shield part 16b, has two apertures 17 and 18 therein to facilitate access to electrical connectors 10 and 11 by lower ends of pins 2 and 3.

Apertures 17 and 18 have shrouds so that the connection between lower ends of pins 2 and 3 and connectors 10 and 11 are enclosed by the cover 16.

The cover 16, made of fire retardant material shields at least the primary winding (“high voltage”) connection parts of the transformer in a fire retardant manner as required by the appropriate safety standards. An advantage of the invention is that it allows the outer enclosure 1 to be made to a less fire-retardant standard. The cover 16 provides the necessary electrical protection. This reduces costs as a lower quantity of fire retardant material is required for the shield 16 while still providing a satisfactory level of safety for the transformer.

The choice of material for the shield 16 depends on the operating temperature and normal fault operating temperature of the transformer. By way of example only, if the maximum abnormal/fault temperature required is 160° C. then a suitable plastic is Polybutylene Terephthalate (PBT) which has the following properties:

Flammability at 0.8 mm thick is 94V-0,

Thermal Properties: Heat deflection temperature at 0.45 Mpa is 220° C., Melting Point is 225° C., and Rated Temp at 0.75 mm thick is 140° C.

It is possible that the connectors 10 and 11 be omitted and the electrical pins 2 and 3 be in direct electrical contact with the tails of the primary winding 7.

Where in the foregoing description reference has been made to integers or elements have known equivalents then such are included as if individually set forth herein.

Embodiments of the invention have been described, however it is understood that variations, improvement or modifications can take place without departure from the sprite of the invention or scope of the appended claims.

1. An electrical transformer, comprising:
a housing,
a core located within the housing,
a primary transformer winding carried by the core and having first and second tails,
a secondary transformer winding carried by the core,
first and second electrical connectors connected electrically to respective said tails of the primary transformer winding, and
a shield positioned between the tails of the primary transformer winding and the housing.

2. The transformer of claim 1 wherein the shield is fire-retardant.

3. The transformer of claim 2 wherein the shield extends between the primary winding and the housing.

4. The transformer of claim 3 wherein said or another shield extends between the secondary winding and the housing.

5. The transformer of claim 2 further comprising an electrical pin assembly detachable from the first and second electrical connectors, said pin assembly comprising a pair of pins that project from the housing to facilitate connection of the transformer with an electrical wall outlet.

6. The transformer of claim 2 further comprising a winding bobbin that is formed integrally with the shield.

7. A battery charger comprising:
a housing,
a core located within the housing,
a primary transformer winding carried by the core and having first and second tails,
a secondary transformer winding carried by the core,
first and second electrical connectors connected electrically to respective said tails of the primary transformer winding, and
a fire-retardant shield positioned between the tails of the primary transformer winding and the housing.

8. The battery charger of claim 7, wherein the primary winding is formed on a bobbin that is formed integrally with the shield.
